(19) United States
(12) Patent Application Publication
(10) Pub. No.: US 2006/0068367 A1
(43) Pub. Date: Mar. 30, 2006

(54) System and method for content management in a distributed learning system

(76) Inventors: Helen Meriwether Parke, Greenville, NC (US); Jeffrey Scott Wojnar, Chandler, AZ (US); Sherman Q. Mohler, Gilbert, AZ (US); Rodney J. Hing, Phoenix, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/209,196

(22) Filed: Aug. 22, 2005

Related U.S. Application Data
(60) Provisional application No. 60/603,072, filed on Aug. 20, 2004.

(51) Int. Cl. G09B 7/00

(52) U.S. Cl. 434/362

(57) ABSTRACT

An online learning system for teaching students is described. One feature of the system is the capability of linking course content that was created for a first course into the content of a second course. Authors of course material can thereby use material that was already created, and is being updated, by a different author within their own courses.

### RELATED APPLICATIONS

This application claims the benefit of, and incorporates by reference in its entirety, U.S. Provisional Application No. 60/603,072, filed on Aug. 20, 2004.

### BACKGROUND OF THE INVENTION

1. Field of the Invention

The present invention relates in general to systems and methods for learning over a computer network and in particular to a personalized, network-based, distributed learning system. More specifically, the invention relates to linking course material from one course into another course in an online learning system.

2. Description of the Related Technology

Distributed learning systems, such as the one described in U.S. application Ser. No. 10/090,056, filed Feb. 27, 2002, entitled “SYSTEM FOR DISTRIBUTED LEARNING, provide for the authoring of powerful yet flexible courses of learning. These courses are deployed over wide area computer networks, such as the Internet, to users in order to provide an on-line personalized learning system. Within such systems are configurable learning objects. Each learning object can be thought of as an instructional course that includes the appropriate instructional content along with testing information for determining whether or not a student has learning the content.

Such systems allow an author to model relationships between learning objects based upon learning objectives. Unfortunately, in doing so such systems tend to create distinct learning boundaries between, for example, different, but related, courses. Such boundaries generally artificially restrict the ability of an author to dynamically reuse other learning content that may relate to the learning objectives of the course under development. Thus, a need exists for systems and methods of allowing content to be shared across learning boundaries.

### SUMMARY OF CERTAIN INVENTIVE ASPECTS

The system, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Inventive Aspects” one will understand how the features of this invention provide advantages that include, for example, dynamically sharing learning content across learning boundaries such as between different courses.

One embodiment includes an online teaching system. The system includes a first online course. The course includes first data objects that include first course material to be taught to a first student. The system further includes a second online course. The course includes second data objects that include second course material to be taught to a second student. The second online course further includes a data link to one or more of the first data objects.

Another embodiment includes a method of presenting course material to a student. The method includes providing a first teaching course to a first student. The first teaching course includes first data objects that include course material. The method further includes providing a second teaching course to a second student. The second teaching course includes second data objects that includes course material. The second teaching course further includes a data link to the first data objects.

Another embodiment includes an online teaching system configured to allow cross course linking between courses. The system includes means for providing a first teaching course to a first student. The first teaching course includes first data objects that include course material. The system further includes means for providing a second teaching course to a second student. The second teaching course includes second data objects that include course material. The second teaching course further includes a data link to the first data objects.

### BRIEF DESCRIPTION OF THE DRAWINGS

The above and other aspects, features and advantages of the invention will be better understood by referring to the following detailed description, which should be read in conjunction with the accompanying drawings. These drawings and the associated description below are provided to illustrate certain embodiments and inventive aspects, and not to limit the scope of the invention.

FIG. 1 illustrates a block diagram of a distributed learning system, according to aspects of an embodiment of the invention.

FIG. 2 illustrates a block diagram of an authoring and management interface system, according to aspects of an embodiment of the invention.

FIG. 3 illustrates a block diagram of an internal and external cache system, according to aspects of an embodiment of the invention.

FIG. 4 illustrates a block diagram of a delivery engine, according to aspects of an embodiment of the invention.

FIG. 5 illustrates a block diagram of an application programming interface layer, according to aspects of an embodiment of the invention.

FIG. 6 illustrates a structure diagram of a course structure, according to aspects of an embodiment of the invention.

FIG. 7 illustrates a screen display of a lesson display screen, according to aspects of an embodiment of the invention.

FIG. 8 illustrates a process flow diagram of a defining learning objectives parameters process, according aspects of an embodiment of the invention.

FIG. 9 illustrates a process flow diagram of a dynamic generation of curriculum process, according to aspects of an embodiment of the invention.

FIG. 10 illustrates a block diagram of a dynamically generated curriculum system, according to aspects of an embodiment of the invention.

FIG. 11 illustrates a process flow diagram of a dynamically generated curriculum process, according to aspects of an embodiment of the invention.

FIG. 12 illustrates a block diagram of a dynamically generated curriculum system with external cache, according to aspects of an embodiment of the invention.

FIG. 13 illustrates a process flow diagram of a dynamically generated curriculum process with external cache, according to aspects of an embodiment of the invention.

FIG. 14 illustrates a block diagram of a list of available active exams retrieval system, according to aspects of an embodiment of the invention.

FIG. 15 illustrates a process flow diagram of a list of available active exams retrieval process, according to aspects of an embodiment of the invention.

FIG. 16 illustrates a block diagram of an exam commencement system, according to aspects of an embodiment of the invention.

FIG. 17 illustrates a process flow diagram of an exam commencement process, according to aspects of an embodiment of the invention.

FIG. 18 illustrates a process flow diagram of an exam customization process, according to aspects of an embodiment of the invention.

FIG. 19 is a block diagram illustrating relationships between a course and content items in other courses.

### DETAILED DESCRIPTION OF CERTAIN INVENTIVE ASPECTS

Certain embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions described herein.

A. Overview

Embodiments of the present invention relate to a distributed learning system. The learning system allows for the dynamic creation of teaching materials personally tailored for the needs of the individual striving to learn the course material. Preferably, the learning system contains dynamic, cross course links that allow an author to use content from within one course as part of a second course.

Within embodiments of the system, the instructional content is divided into a series of content objects, each of which contains information for the student. The content objects may include text, pictures, videos, sounds or any combination of these elements. When the course is created, the author chooses a particular style, or format, that is used for displaying the content objects to the student.

Each content object can be dynamically rendered using any format chosen by the author. In addition, new formats can be developed so that the original content can be given a different look and feel. Thus, the content and the style for presenting that content are separate from one another. Accordingly, each content item can thereby be rendered and displayed to a student in any format.

As discussed below, since course content is stored within embodiments of the systems as modular objects, one set of course material can refer to content objects associated with a second set of course material. Accordingly, the content, or portion of content, from a first course can be easily used within the structure of a second course. This provides tremendous advantages over prior course materials that were static in nature, and did not allow for cross-course linkages. The modular approach, and dynamic generation capabilities of the system described below provides these advantageous capabilities.

Embodiments of the system allow for courses to be designed and presented to students over a network, such as the Internet. Each course includes at least one Learning Object (LO) that includes all of the content items, assessment items, and other required data to carry out a particular learning objective. One learning objective, for example, might be to learn how to fly a plane, or program a computer. This is an example of a very broad learning objective. Accordingly, each learning objective may include a defined set of target indicators (TI's). For example, the learning objective could be Visual Basic knowledge and the TI's might include command instructions in Visual Basic or display techniques of Visual Basic. Accordingly, each TI could include an indicator that the student has learned the learning objective. The overall course could be called “How to Program a Computer” or “How to fly an airplane”.

In order to teach a student a TI, a series of content items (CI's) can be provided. Each content item includes information that relates to its TI. For example, if the TI is Visual Basic knowledge, related content items might include text pages showing Visual Basic commands. Each page displays a one or more content item. Alternatively, a set of related commands might also be a single content item. In addition, content items can be video files, text files or sound files that provide information for the particular target indicator.

Associated with the content items are one or more assessment items (AI's), which are typically examination questions that test the student's knowledge of the content item. For example, if the content item includes text that teaches how to use the command “PRINT” from Visual Basic, the assessment item might include a question such as “What command is used to print to the printer?” This allows assessment of the student's knowledge of the content item. Obviously, such a test would not necessarily have to be in written form, but could also be performed through video or sound files. Because of the relationship between content items and assessment items, the system can provide a very granular analysis of what a particular student has learned. By providing a set of assessment items that test for knowledge of particular content items, instructions within the system can determine which content items have been learned by the student, and which content items are not known.

Once a determination is made of the content items that need to be learned, embodiments of the system can provide varying types of content items to teach the student. For example, if the student cannot answer the question “What command is used to print to the printer?”, the system can then display additional Visual Basic command text, play a video, or play a sound file that instructs the student on the use of the command “PRINT”.

As discussed below, a student can access the course through a computer system. In one embodiment, the course is presented within a browser software program such as Internet Explorer from Microsoft Corporation, or Netscape Navigator from Netscape Corporation. Once the student has requested the course, the course is presented to the student through the browser software executing on the student's computer system.

In some cases, the developer of course content, for example, “How to Use a Web Browser,” may wish to provide a learner with access to related or prerequisite knowledge. For example, the developer of “How to Use a Web Browser,” may wish to provide content from course such as “How to Use a Personal Computer.” Simply launching into another course may be undesirable because the other course may formatted differently, may not allow for easy correlation of assessment within the parent course. Moreover, the developer may prefer to only link to a specific content item, such as “How to Print” from within the “How to Use a Personal Computer” course. Simply copying the content into the new course is generally inefficient because it may require maintaining distinct versions of essentially the same content. As described below, some embodiments may thus also dynamic sharing of content across learning boundaries, e.g. between courses. Thus, learners can access related learning objects between courses without the need for the developer to maintain different versions or copies of the content in different courses.

B. Definitions

1. Application Programming Interface (API)

An API is a set of routines, protocols, and tools for building software applications. An API facilitates the development of software programs or systems by providing the building blocks that may be utilized in building a software program or system. A programmer can then access and use the API to create or modify a software program or system.

2. Assessment Items

Assessment items are queries that may be posed to the student to indicate the student's comprehension of the course material. The assessment items can be content-related questions, such as, for example, true or false questions, multiple choice questions, fill-in-the-blank questions, point and click questions, drag-and-drop questions, free text questions, and the like.

3. Content Items

Content items refer to the presentation of educational material, including any tools that can deliver or contain educational content. Content items can be in many forms, such as, for example, Microsoft Word documents, Microsoft PowerPoint presentations, Flash animations, streaming video, collaborative work environments, or any tool that can deliver educational content.

4. Course

A course can include one or more learning objects, and is designed to teach a certain curriculum to a student. A course can be designed and presented to students over a network, such as the Internet. Each course may be composed of one or more learning objects that carry out a particular learning objective.

5. Input Devices

Input devices are capable of transmitting information from a user to a computer, for example, a keyboard, rollerball, mouse, voice recognition system or other device. The input device may also be a touch screen associated with the display, in which case the user responds to prompts on the display by touching the screen. The user may enter textual information through the input device such as the keyboard or the touch-screen.

6. Instructions

Instructions refer to computer-implemented steps for processing information in the system. Instructions can be implemented in software, firmware or hardware and can include any type of programmed step undertaken by components of the system.

7. Local Area Network (LAN)

One example of the Local Area Network may be a corporate computing network, including access to the Internet, to which computers and computing devices comprising the system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware, and Banyan VINES.

8. Learning Objectives

Learning objectives refer to major topics, i.e. educational goals, which are typically not easily assessable. The learning objectives may include broad concepts, such as, for example, “Understanding the Use of a Web Browser”. A learning objective typically is separated into smaller conceptual units (target indicators) which can be more easily taught and tested. A learning objective is generally generated by a job task or skills analysis. One or more learning objectives normally form a complete course.

9. Learning Object

A learning object is a data object that includes an accumulated set of materials and assets that address a stated set of learning objectives. Preferably, the learning object can then be cohesively combined to satisfy a higher level taxonomy of learning objectives. Mastery of course content may be tracked at not only the learning object level, but also at various levels in the learning objective hierarchy.

10. Media

Media refers to images, sounds, video or any other multimedia type data that is entered into the system.

11. Microprocessor

The microprocessor may be any conventional general purpose single- or multi-chip microprocessor, such as a Pentium® processor, a Pentium® Pro processor, a 8051 processor, a MIPS® processor, a Power PC® processor, an ALPHA® processor, or other general purpose microprocessor, including those yet to be developed. In addition, the microprocessor may be any conventional special purpose microprocessor, such as a digital signal processor or a graphics processor. The microprocessor typically has conventional address lines, conventional data lines, and one or more conventional control lines.

12. Modules

A system is comprised of various modules as discussed in detail below. As can be appreciated by one of ordinary skill in the art, each of the modules may comprise various sub-routines, procedures, definitional statements and macros. Each of the modules are typically separately compiled and linked into a single executable program. Therefore, a description of each of the modules is used for convenience to describe the functionality of certain embodiments of the system. Thus, the processes that are undergone by each of the modules may be arbitrarily redistributed to one of the other modules, combined together in a single module, or made available in, for example, a shareable dynamic link library.

13. Networks

The system may include any type of electronically connected group of computing systems, including, for example, one or more of the networks from the following non-exhaustive list: Internet, Intranet, Local Area Networks (LAN) or Wide Area Networks (WAN). In addition, the connectivity to the network may be, for example, by way of remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, wireless, set-top, or any other desired type of configuration. As used herein, an Internet includes network variations such as public Internet, a private Internet, a secure Internet, a private network, a public network, a value-added network, an Intranet, and the like. In other words, as used herein, the term network refers to any type of connectivity between computing devices for the transfer of data.

14. Operating Systems

The system may be used in connection with various operating systems, such as those from the following non-exhaustive list: UNIX, Disk Operating System (DOS), OS/2, Windows 3.X, Windows 95, Windows 98, Windows NT, including other operating systems yet to be developed. New operating systems and revisions of existing operating systems are continually being developed, and these are also within the scope of the present invention.

15. Programming Languages

The system may be written in any programming language such as C, C++, BASIC, Pascal, Java, and FORTRAN, and executed under one or more of the many well-known operating systems. C, C++, BASIC, Pascal, Java, and FORTRAN are industry standard programming languages for which many commercial compilers can be used to create executable code.

16. Target Indicators

Target indicators are assessable educational sub-topics that are portions of the broader learning objective. Each learning objective may be composed of one or more target indicators.

17. Transmission Control Protocol

Transmission Control Protocol (TCP) is a transport layer protocol used to provide a reliable, connection-oriented, transport layer link among computer systems. The network layer provides services to the transport layer. Using a two-way handshaking scheme, TCP provides the mechanism for establishing, maintaining, and terminating logical connections among computer systems. TCP transport layer uses Internet Protocol (IP) as its network layer protocol. Additionally, TCP provides protocol ports to distinguish multiple programs executing on a single device by including the destination and source port number with each message. TCP performs functions such as transmission of byte streams, data flow definitions, data acknowledgments, lost or corrupt data re-transmissions and multiplexing multiple connections through a single network connection. Finally, TCP is responsible for encapsulating information into a datagram structure.

C. Overview of the System

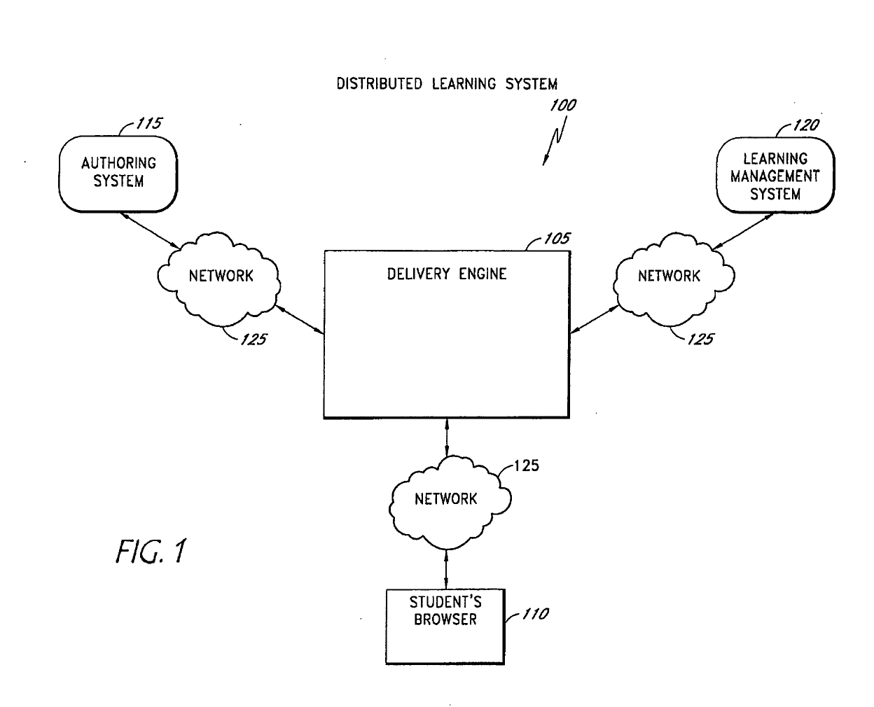

FIG. 1 illustrates a block diagram of one embodiment of a distributed learning system 100. As shown, the distributed learning system 100 includes a delivery engine 105 for delivering content though the system. The delivery engine 105 sends content data to a student's browser 110 via a network 125. In addition, authors can use an authoring system 115 that is linked via the network 125 to the delivery engine 105 to create content. Also, a learning management system 120 communicates with the delivery engine 105 via the network 125 in order to control the flow of content through the system. These modules and systems are explained in more detail with regard to the following figures.

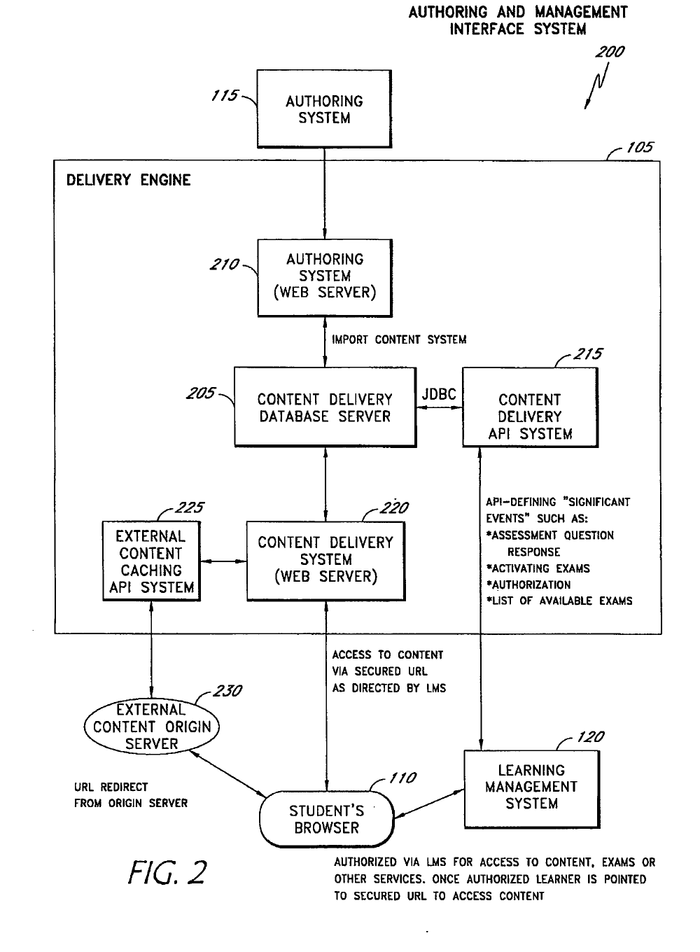

FIG. 2 illustrates a block diagram of one embodiment of the learning system 100. As shown, the authoring and management interface system 200 includes the delivery engine 105, the student's browser 110, the authoring system 115, the learning management system 120, and an external content origin server 230.

In one embodiment, the delivery engine 105 includes a content delivery database server 205 that stores content items from the authoring system 115. These content items are developed for eventual delivery to the students as part of a curriculum. As discussed above, these content items can include text, video or sounds that are part of a particular curriculum being taught. The delivery engine 105 also includes an authoring system server 210, a content delivery API system 215, a content delivery system 220, and an external content caching API system 225.

In this embodiment, the content delivery database server 205 comprises a database server, such as a SQL server. However, any database system capable of storing and retrieving information, such as those commercially available from, for example, the Oracle Corporation or IBM, is within the scope of the present invention. The delivery engine 105 is capable of using the content delivery database server 205 for storing, accessing and retrieving a variety of information.

In one embodiment, the authoring system server 210 comprises a web server. Web servers, which are of widespread use in the technology, are capable of transmitting content over the Internet using one or several Internet language protocols, for example the Hypertext Mark Up Language (HTML) or the Extensible Mark Up Language (XML). A web server can be configured to accept requests from Internet web browsers and return the appropriate electronic documents pursuant to the request. A number of servers or client-side technologies can be used to increase the power of the web server beyond its ability to deliver standard electronic documents. For example, such technologies include Common Gateway Interface (CGI) scripts, Secure Sockets Layer (SSL) security, and Access Server Pages (ASP's).

In one embodiment, the authoring system server 210 includes an API used to accept content from external authoring systems. This external content may be XML tagged by the authoring system server 210 in accordance with a predefined data type definition (DTD). The authoring system server 210 tags the incoming content in such a way that the intended target computer is able to identify the purpose of the data. For example, the content may be tagged differently depending on whether the incoming content is a learning object, a TI or Cl's associated with a learning object or a TI, etc. The authoring system server 210 is capable of transferring information between the authoring system 115 and the content delivery database server 205. The authoring system 115 and the authoring system server 210 can use an API that defines XML definitions of data and automatic content procedures. Using the API, the authoring system 115 can create and modify courses on the delivery engine 105. The content delivery database server 205 in configured to use an import content service to receive information from the authoring system server 210. The content delivery database server 205 is capable of receiving requests from the authoring system server 210 for storing, accessing and retrieving a variety of information.

As disclosed in the foregoing, FIG. 2 illustrates the authoring and management interface system 200. As shown in FIG. 2, the content delivery API system 215 transfers information between the learning management system 120 and the content delivery database server 205. The learning management system 120 and the content delivery API system 215 use an API that defines significant events detected by the system. The significant events include events such as a student's response to an assessment question, a request to activate an exam, a request for authorization, a request for a list of available exams, and the like. In one embodiment, the content delivery API system 215 communicates with the content delivery database server 205 by Java DataBase Connectivity (JDBC). JDBC is a Java specification for connecting to SQL-based databases.

As shown in FIG. 2, the content delivery system 220 exchanges information between content delivery database server 205 and the student's browser 110. In one embodiment of the invention, the content delivery system 220 is a web server, although in other embodiments the content delivery system 220 may be other types of computing devices. The student's browser 110 and the content delivery system 220 may communicate via Hypertext Transfer Protocol (HTTP), or by way of other data transfer methods. In another embodiment of the invention, the student's browser 110 and the content delivery system 220 communicate using a secured communications protocol, such as, for example, secured URL, Hypertext Transfer Protocol Secure (HTTPS), or the like.

As shown in the embodiment of FIG. 2, the delivery engine 105 includes the external content caching API system 225. The external content caching API system 225 communicates with an external content origin server 230 to provide educational content, from sources external to the delivery engine 105, to the student's browser 110. In one embodiment, the student's browser 110 and the external content origin server 230 advantageously use URL redirects from the original server to communicate. Therefore, the student's browser 110 may receive content directly from the delivery engine 105, or the student's browser 110 may receive content indirectly from the delivery engine 105 via the external content origin server 230.

The learning management system 120 also communicates with the student's browser 110. A student using the student's browser 110 may communicate with the learning management system 120 to gain access to the delivery engine 105. Once access is gained, the student's browser 110 may retrieve content, exams, and other services available through the delivery engine 105. The student's browser 110 and the learning management system 120 may communicate using a secured communications protocol, such as, for example, secured URL, Hypertext Transfer Protocol Secure (HTTPS), or the like.

The content items in the learning system 100 may be stored in a database structure in the content delivery database server 205. In this way, the content in the system is reusable. The content items or target indicators in the database may be reused for placement in another target indicator. Thus, any content or course developer can use the database and utilize the content items.

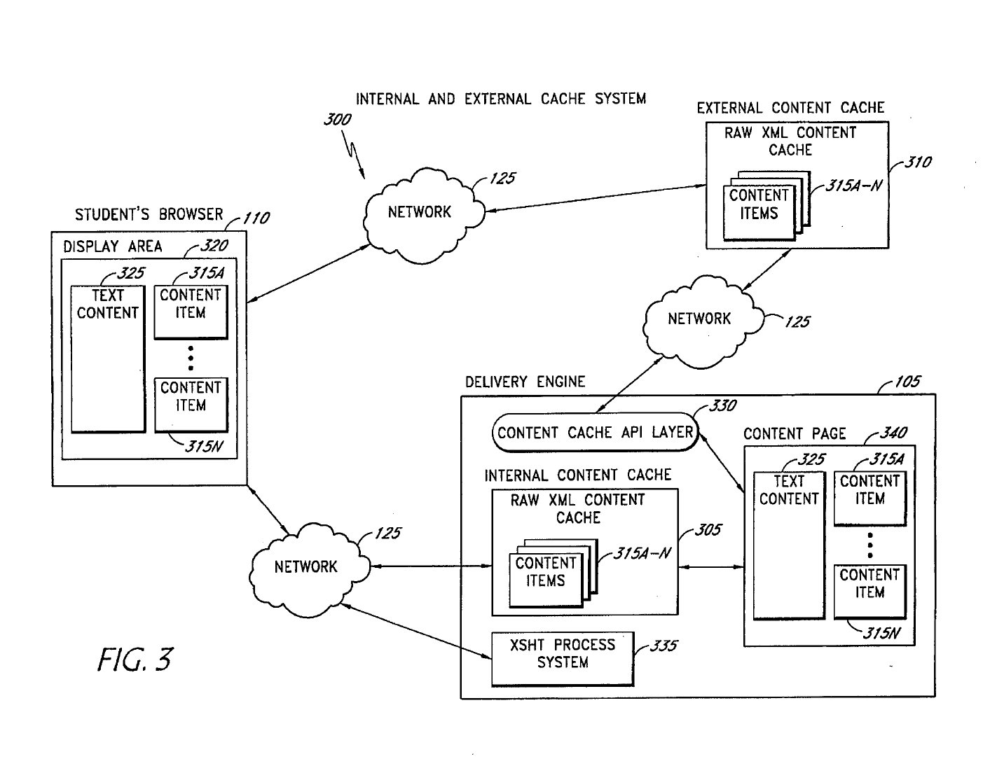

FIG. 3 illustrates one embodiment of a block diagram of an internal and external cache system 300. As shown, the delivery engine 105 delivers content to the student's browser 110 through an internal content cache 305 and/or an external content cache 310. The external content cache 310 may be utilized if provided, but it need not be provided for the system to operate. The delivery engine 105, the external content cache 310, and the student's browser's 110 communicate with each other via the network 125.

The internal content cache 305 and the external content cache 310 provide one or more content items 315A-315N to the student's browser 110. As used herein, a single content item may be referred to as, for example, the ‘content item 315A’ or the ‘content item 315B’, specifying a particular one content item from the list of content items 315A-315N shown in FIG. 3. The ‘content item 315N’ refers to the last content item in the list, where ‘N’ indicates that any number of content items may be included. The ‘content items 315A-315N’ refer to the list of content items, which may be comprised of one or more individual content items.

The student's browser 110 includes a display area 320 that can be viewed by the student. The display area 320 includes one or more text content 325 and one or more content items 315A-315N. The display area 320 displays a content page 340 created by the delivery engine 105. The content page 340 includes one or more text contents 325 and one or more content items 315A-315N. In one embodiment, the content page 340 includes style sheets for formatting the content in a consistent manner, even if different types of content are delivered.

The delivery engine 105 includes the internal content cache 305, a content cache API layer 330, and a XSLT process system 335. The content items 315A-315N can reside on the internal content cache 305 or the external content cache 310. In one embodiment of the invention, the delivery engine 105 transmits the content page 340 to the student's browser 110 where a portion of the content items 315A-315N are provided by the internal content cache 305 and where a portion of the content items 315A-315N are provided by the external content cache 310. The XSLT process system 335 applies the designated style sheet to the content page 340 for display on the display area 320 of the student's browser 110.

Content items and assessment items are capable of being dynamically rendered within the student's browser 110 from the delivery engine 105. The delivery engine 105 thereby provides one means for dynamically rendering course content to a student. As described above, the content items and assessment items are capable of being stored in a database. To deliver content, the system can use a target indicator map that associates a learning objective with one or more target indicators. The system also provides a page map that describes the content items to be displayed in a page. Once the page map is accessed, the page request is submitted to the XSLT process 335 to determine the style sheet to be used for the particular content page 340. Once the style sheet is determined, the web page is presented to the student's browser 110. If the page contains additional embedded items, the system makes additional requests for the additional embedded items. This process can also be followed when presenting assessment exams and items within the exams.

As described in the above embodiment, content items and assessment items that are embedded in a page may be addressed with a Uniform Resource Locator (URL) or by Hypertext Transfer Protocol (HTTP). Therefore, the content can be physically located in a distributed cache environment with a server that controls and maps the cached content objects and can issue URL redirect commands for embedded objects with the dynamically rendered page. The content cache API in the delivery engine 105 uses the address of the origin server to forward requests for embedded objects to the origin server.

The content delivery engine 105 renders the supported content item types and question types imported from the external authoring systems. The object types can include dynamic object types. The content delivery engine 105 preserves the presentation look and feel created by the author or instructional designer. The content delivery engine 105 further assembles and delivers assessment and course media elements. The elements can be expressed in various forms, such as, for example, Extensible Markup Language (XML) or any Multipurpose Internet Mail Extensions (MIME) types, such as, for example, text, multi-part, message, applications, image, audio, video, model, and the like.

The supported content item types may include those from the following non-exhaustive list: description, question, image, list, HTML, table, slide show, summary, and the like. The system is capable of supporting a variety of assessment types, such as, for example, true or false questions, multiple choice questions, fill-in-the-blank questions, point and click questions, drag and drop questions, free text questions, and the like.

The content delivery engine 105 is capable of adding specific themes to the content depending on the author or LMS preferences, thus preserving a constant look and feel. The look and feel may include factors such as colors, header font, button shapes, university logo, and the like.

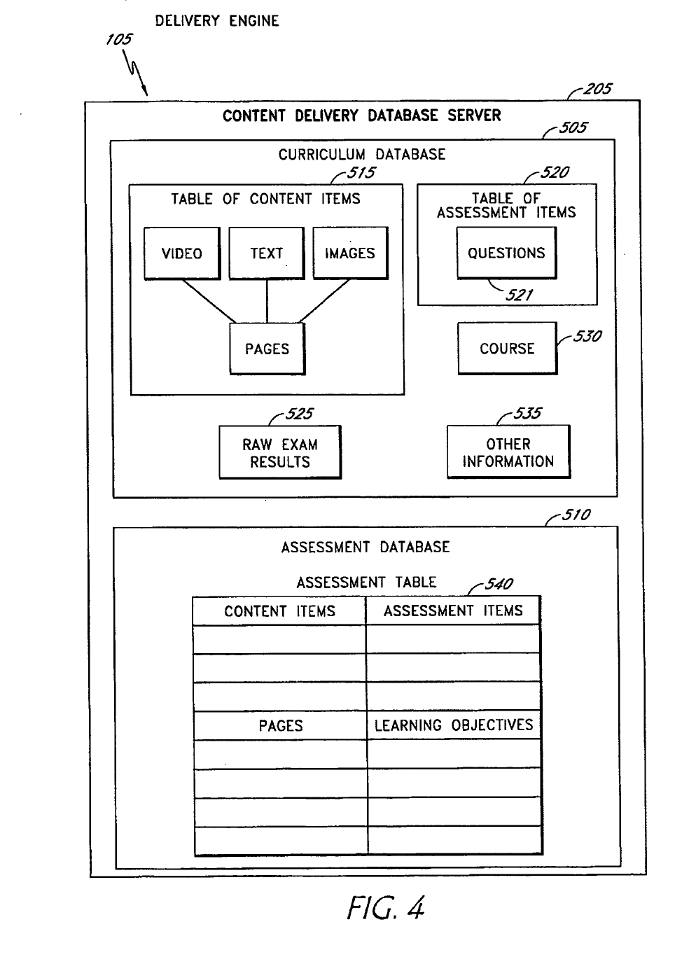

FIG. 4 illustrates a block diagram of the delivery engine 105, according to aspects of an embodiment of the invention. The delivery engine 105 includes the content delivery database server 205. In one embodiment, the content delivery database server 205 includes a curriculum database 505 that stores certain data relating to the student's curriculum. The curriculum database 505 may include a table of content items 515 which can include video, text, images, and HTML pages that relate to one or more target indicators. In addition, a table of associated assessment items 520 is also included within the curriculum database 505. The table of assessment items 520 can include stored questions 521 that can be transmitted to the student's browser 110.

In addition, the content delivery database server 205 may also capture and store raw exam results 525, course information 530, and any other information 535. Also, an assessment database 510 may include an assessment table 540 that maintains a link between each content item and its associated assessment items. The assessment table 540 comprises information on content items, assessment item, displayed pages, and learning objectives.

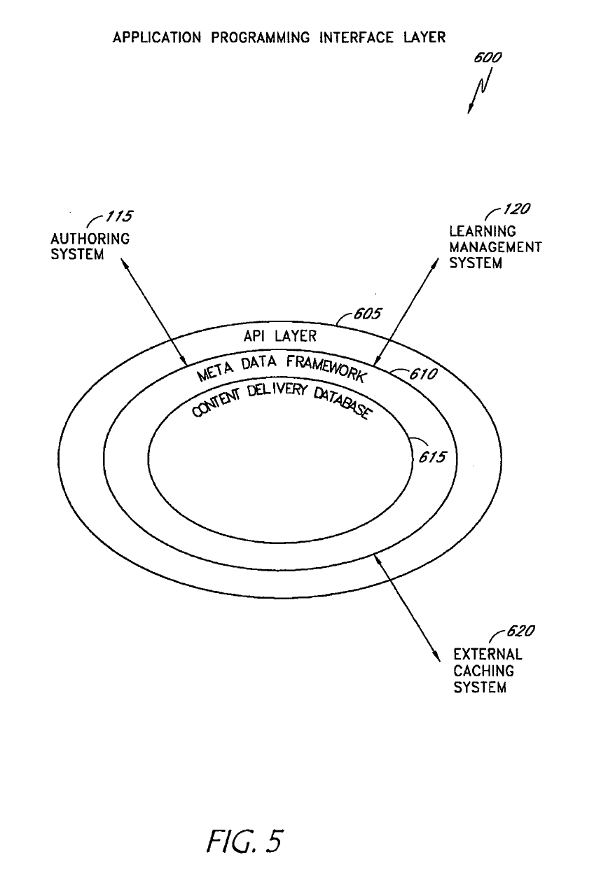

FIG. 5 illustrates a block diagram of an application programming language interface layer 600, according to aspects of an embodiment of the invention. As shown, an API layer 605 encompasses a meta data framework 610. The meta data framework 610 encompasses a content delivery database 615.

The authoring system 115, the learning management system 120, and an external caching system 620 are capable of communicating with the meta data framework 610. The function of the API layer is to allow the content delivery engine 105 to communicate with any external authoring system, learning management system, or content caching scheme. The system has published and defined API's that can be used by external systems to communicate with the content delivery engine 105.

The API layer 605 enables the exchange of data between the content delivery engine 105 and external authoring systems in a standard format. The data may include both curriculum and assessment content. The API defines the process for receiving an export package from a designated FTP site. The API also defines the import content in XML format via the authoring to delivery API, including curriculum content, assessment content and the associated meta data for both types of content. If the API detects errors during the communication, the content may be sent to the authoring system, via the API, for correction or other appropriate action.

Further, the API enables delivery to learning management conversations. The delivery database includes information such as course content, assessment questions, assessment exams, raw exam results, student profiles and other information that the learning management system 120 is able to display to the student, processing by the management system (such as exam results) or tracking a learner's progress through the course.

The delivery engine 105 can communicate with one or more communication schemes, such as, for example, synchronous and asynchronous communications paths. An asynchronous conversation includes communications, such as, for example, the delivery engine 105 reporting back to the management system regarding the assessment question responses of a student taking an exam. A synchronous conversation includes communications, such as, for example, a student's browser 110 requesting a list of available exams from the delivery engine 105.

The API can additionally support content caching. When content is imported into the database 615, the content may be stored as an anatomic item that is part of a page. Since the HTML process of building pages is a dynamic process, the content for a page does not need to be stored in the database. The delivery engine 105 can access the content using a URL address, and thus the content need not be stored in the database. Therefore, the content can be placed at various locations around a network, and accessed by the content delivery engine 105 through the URL address of the content.

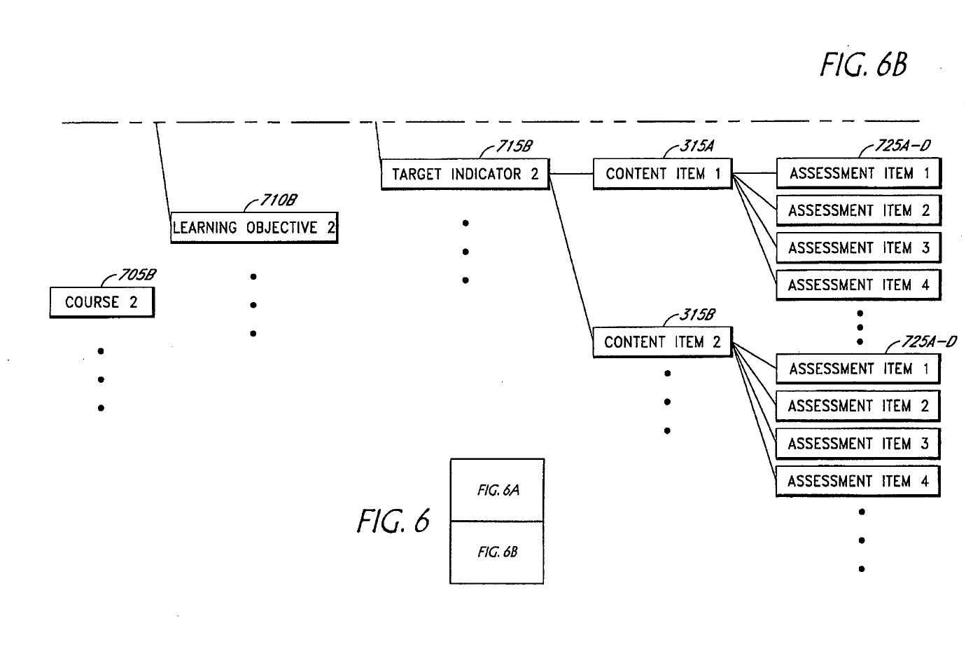

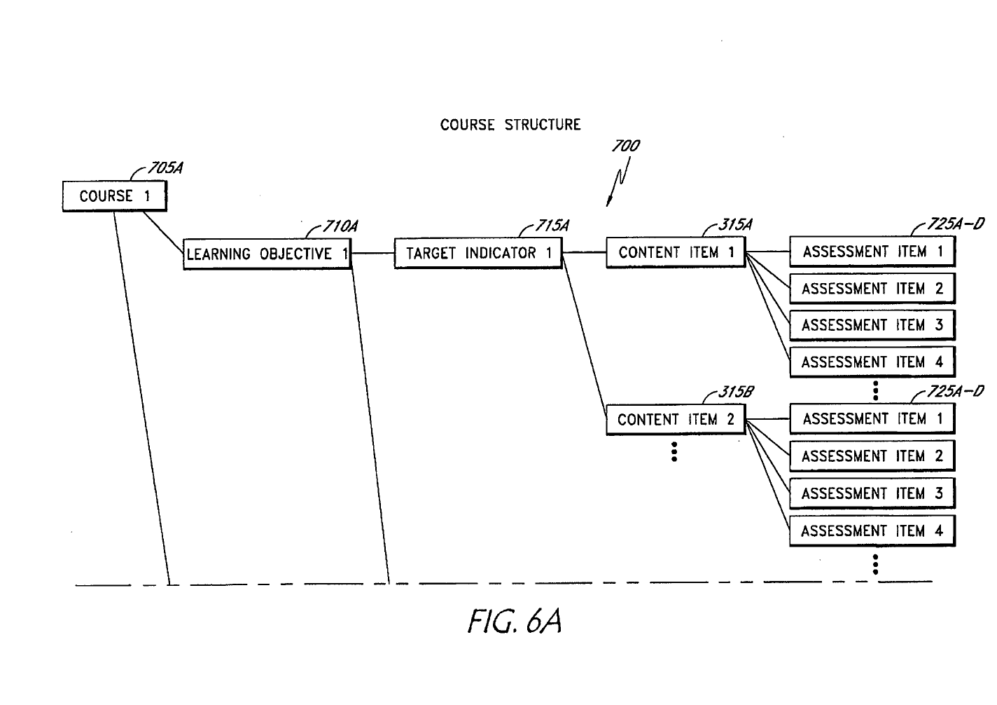

FIG. 6 illustrates a structure diagram of a course structure 700, according to aspects of an embodiment of the invention. As illustrated, a course 705A, 705B comprises one or more learning objectives 710A, 710B. Each of the learning objectives 710A, 710B comprise one or more target indicators 715A, 715B. Each of the target indicators 715A, 715B comprise one or more content items 315A, 315B. Each of the content items 315A, 315B comprise one or more assessment items 725A-725D. Assessment items 725A-725D can also be associated with the target indicators 715A, 715B directly. Assessment items 725A-725D may be associated with the learning objectives 710A, 710B by implementing a two-phase adaptive testing process. For the sake of example, FIG. 6 shows two courses 705A, 705B, two learning objectives 710A, 710B for each course 705A, 705B, two target indicators 715A, 715B for each learning objective 710A, 710B, two content items 315A, 315B for each target indicator 715A, 715B, and four assessment items 725A-725D for each content items 315A, 315B. However, as represented by the ellipses in FIG. 6, the number of each of these items actually shown is for the purpose of example only, and more or fewer of each of these items may be present in the various embodiments of the course structure 700.

In the embodiment shown in FIG. 6, each course 705A, 705B is composed from a set of learning objectives 710A, 710B. Learning objectives 710A, 710B include major topics that are not directly assessable. The learning objectives 710A, 710B may include broad concepts, such as, for example, “Understanding the Use of a Web Browser”. These concepts may be broken down into smaller conceptual units that can be tested and directly assessed. The learning objectives 710A, 710B are generally generated by a job task or skills analysis. Together, the learning objectives 710A, 710B form the course 705A, 705B.

Further, for each learning objective 710A, 710B, specific target indicators 715A, 715B may be generated. Target indicators 715A, 715B include assessable subtopics. For example, if a learning objective 710A, 710B is “Understanding the Use of a Web Browser”, a specific target indicator 715A, 715B may be, for example, “Understanding How to Enter a URL”, or “Understanding How to Print from a Web Browser”, or the like.

Each target indicator 715A, 715B may include one or more content items 315A, 315B. Content items 315A, 315B can be in many forms, such as, for example, Microsoft Word documents, Microsoft PowerPoint presentations, Flash animations, streaming video, collaborative work environments, or any similar tool that can deliver educational content. Each content item 315A, 315B is developed to address a specific target indicator 715A, 715B. Different media elements can cover the same educational content. Thus, the media elements can later be matched with specific learning preferences or styles. For example, primarily text-oriented students may receive more text intensive learning materials, whereas primarily visually-oriented students may receive more media intensive materials. Also, different media elements can be used to reinforce particularly difficult or important concepts.

Thus, a repository of content items 315A, 315B may be built to address an individual target indicator 715A, 715B. The content items 315A, 315B may include anatomic pieces of information that each address the assessable goal of the target indicator 715A, 715B. Each content item 315A, 315B can stand alone or combine with other content items 315A, 315B associated with the specific target indicator 715A, 715B. The content delivery engine 105 can then render the content items 315A, 315B into a presentation, such as an HTML page, and transmit the presentation to the student's web browser. A presentation of content items then becomes a content item itself.

The assessment items 725A-725D include questions that may be asked of the student. Assessment items 725A-725D can be stored in a database. Assessment items 725A-725D can also be associated within the database at the content item level, the page level, or the target indicator level. An assessment generation engine is capable of dynamically creating assessments for each student on demand. The output of the generation process can include a set of assessment questions in presentation format.

The instructor may set assessment attributes in an active assessment page. The attributes may include factors, such as, for example, the duration of the test, the number of attempts (at the assessment question) allowed by the student, the randomization of questions, inclusion of Beta test items for the purpose of analyzing the behavior of test question before it is placed in the active test question pool, and the like. The author of the course can set permissions for granting and restricting course instructor access to modify the default attribute values.

The delivery engine 105 is capable of using an exam activation screen to enable the course instructor to set or change the assessment attributes to which the course instructor has been granted permission to modify. The attributes may include assessment start and end time or date, duration of the test, the number of attempts allowed by the student, randomization of questions, criteria of students qualified to take assessment, question threshold (i.e. the minimum assessment items per content component missed to get prescription), and other attributes.

In one embodiment, the delivery engine 105 is configured to maintain the raw assessment responses (responses are stored in relation to the student) and the overall response map (response map is stored in relation to the question). The external management systems can request student exam information through appropriate calls in the management API. The management system, using the requested student exam information, can determine the score scale for proficiency of the student.

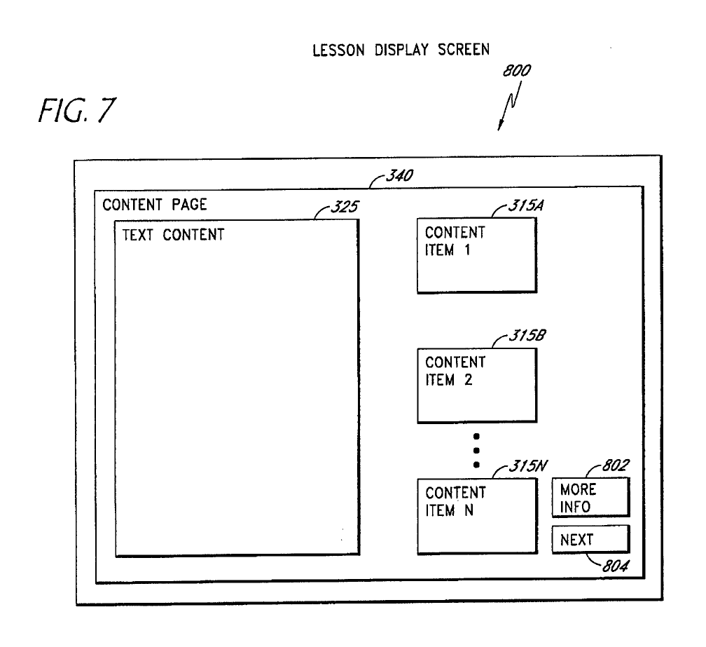

FIG. 7 illustrates a screen display of a lesson display screen 800, according to aspects of an embodiment of the invention. As shown in FIG. 7, the lesson display screen 800 includes the content page 340, which displays teaching information to the student. The content page 340 includes at least one text content 325 and one or more other content items 315A-315N. The content items 315A-315N can include text, video or sound files that relate to the text content 325. In one embodiment, each of the content items 315A-315N and text content 325 relate to a single target indicator. For example, each would provide a different way to teach a student how to program the “PRINT” command in Visual Basic.

In addition, the content page 340 can include other controls, such as a “MORE INFO” button 802 or a “NEXT” button 804. Selecting the button 802 can bring up additional curriculum relating to the target indicator being taught. Moreover, content items 315A-31 SN with varying levels of difficulty can be provided so that the student can challenge themselves with more difficult topics. The system thereafter is capable of tracking the progress and determining the level of the student's knowledge by analyzing the content items they viewed, and their score on assessment items associated with the content items.

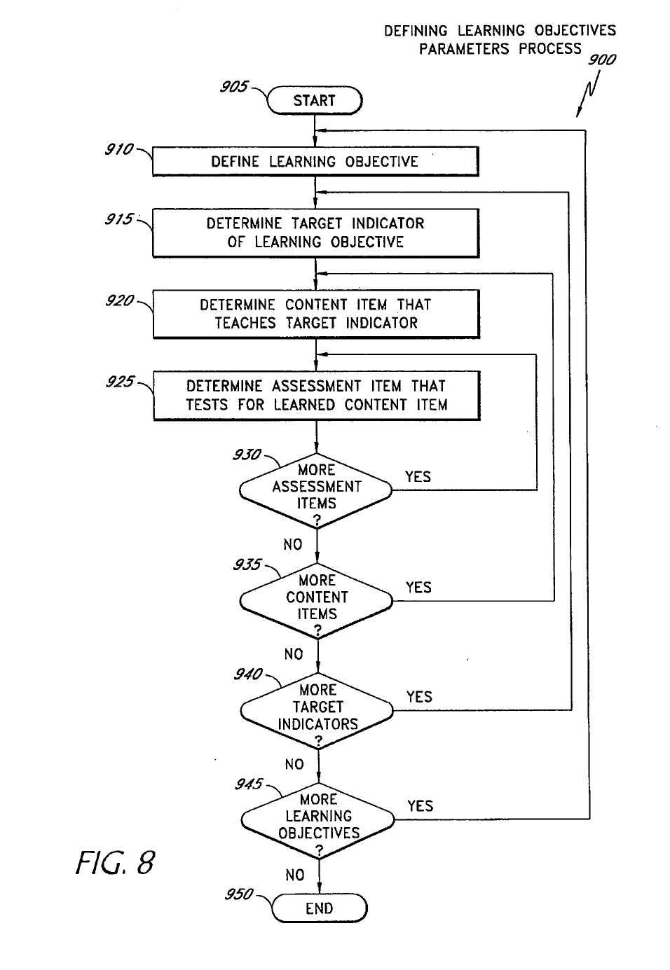

FIG. 8 is a flow diagram illustrating one embodiment of a process 900 for defining learning objectives parameters. This embodiment of the defining learning objectives parameters process 900 starts at Step 905. At Step 910, the author defines a learning objective. After the author defines a learning objective, at Step 915, the author determines the target indicator of the learning objective. After the author determines the target indicator of the learning objective, at Step 920, the author determines the content item that teaches the target indicator. After the author determines the content item that teaches the target indicator, at Step 925, the author determines an assessment item that tests for the learned content item.

After the author determines the assessment item that tests for the learned content item, at Step 930, the author is prompted to indicate whether the author wishes to include more assessment items. At Step 930, if the author wishes to include more assessment items, the process proceeds to Step 925. If, at Step 930, the user does not wish to include more assessment items, the process proceeds to Step 935.

At Step 935, the author is prompted to indicate whether the author wishes to include more content items. At Step 935, if the author wishes to include more content items, the process proceeds to Step 920. If, at Step 935, the author does not wish to include more content items, the process proceeds to Step 940. At Step 940, the author is prompted to indicate whether the author wishes to include more target indicators. At Step 940, if the author wishes to include more target indicators, the process proceeds to Step 915. If, at Step 940, the author does not wish to include more target indicators, the process proceeds to Step 945. At Step 945, the author is prompted to indicate whether the author wishes to include more learning objectives. At Step 945, if the author wishes to include more learning objectives, the process proceeds to Step 910. If, at Step 945, the author does not wish to include more learning objectives, the process proceeds to Step 950. At Step 950, the defining learning objectives parameters process 900 is complete.

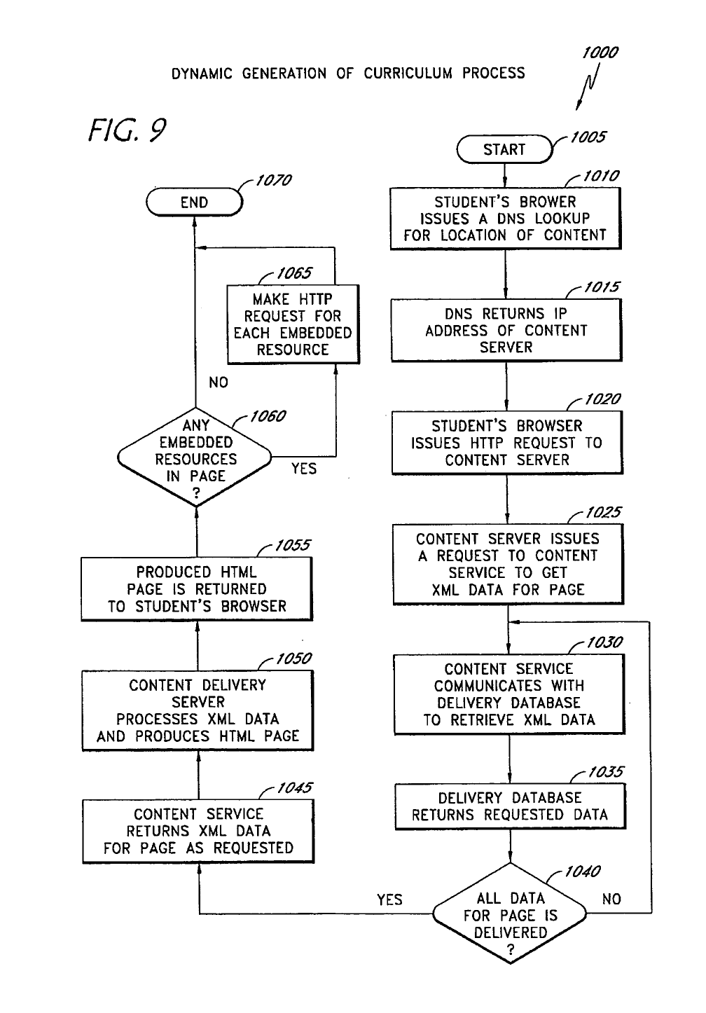

FIG. 9 illustrates one embodiment of a process 1000 for dynamically generating a curriculum for a student. This embodiment of the dynamic generation of curriculum process 1000 starts at Step 1005. At Step 1010, the student's browser issues a DNS look-up for location of a content item. After the student's browser issues a DNS look-up for location of content, at Step 1015, the DNS returns the IP address of a content server. After the DNS returns the IP address of the content server, at Step 1020, the student's browser issues an HTTP request to the content server. After the student's browser issues the HTTP request to the content server, at Step 1025, the content server issues a request to the content service to get XML data for the student's page.

After the content server issues a request to the content service to retrieve XML data for the student's page at Step 1030, the content service communicates with the delivery database to retrieve the requested XML data corresponding to the content. After the content service communicates with delivery database to retrieve the XML data, at Step 1035, the delivery database returns the requested data. After the delivery database returns the requested data, the process proceeds to Step 1040.

At Step 1040, if all data for page is not delivered, the process proceeds to Step 1030. If, at Step 1040, all content data for the page was delivered to the student's browser, the process proceeds to Step 1045. At Step 1045, the content service returns XML data for the page as requested. After the content service returns XML data for the page as requested, at Step 1050, the content delivery web server processes XML data and produces an HTML page. After the content delivery server web server processes XML data and produces the HTML page, at Step 1055, the produced HTML page is returned to the student's browser. After the produced HTML page is returned to the student's browser, the process proceeds to Step 1060.

At Step 1060, if there are no embedded resources in the page, the process proceeds to Step 1070. If, at Step 1060, there are embedded resources in the page, the process proceeds to Step 1065. At Step 1065, an HTTP request is made for each embedded resource. After the HTTP request is made for each embedded resource, the process proceeds to Step 1070. At Step 1070, the dynamic generation of curriculum process 1000 is complete.

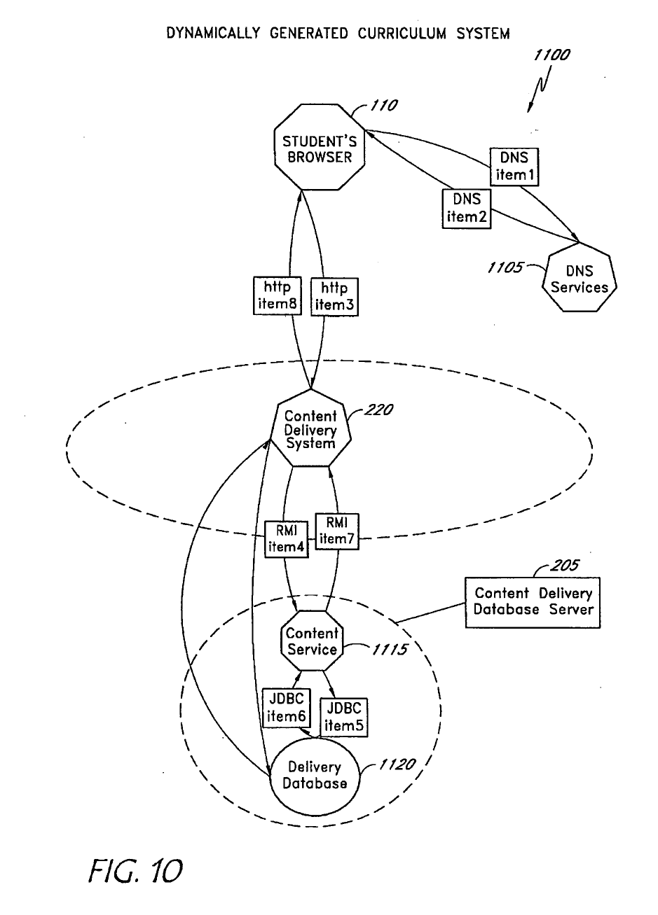

FIG. 10 illustrates one embodiment of a system 1100 that dynamically generates a curriculum. As shown, this embodiment of the dynamically generated curriculum system 1100 includes the student's browser 110, a DNS services module 1105, the content delivery system 220, the content delivery database server 205, a content service 1115 module, and a delivery database 1120. In one embodiment of the invention, the student's browser 110 and the DNS services module 1105 communicate by transmitting DNS items.

In this embodiment, the student's browser 110 and the content delivery system 220 communicate via HTTP. The content delivery system 220 and the content service module 1115 communicate by Remote Method Invocation (RMI). The content delivery system 220 also communicates with the delivery database 1120. The content service 1115 and the delivery database 1120 are capable of communicating via JDBC. The content delivery database server 205 communicates with the content service 1115 and the delivery database 1120. In one embodiment of the invention, the delivery database 1120 is a database such as those commercially available from Oracle, or the like.

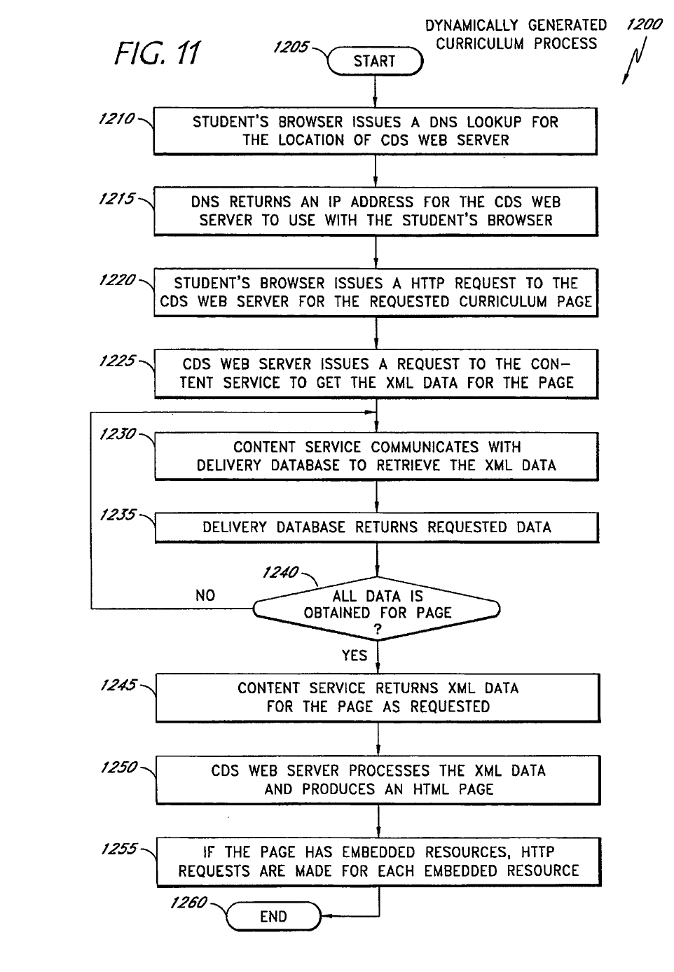

FIG. 11 illustrates one embodiment of a process 1200 for dynamically generating a curriculum. This embodiment of the dynamically generated curriculum process 1200 starts at Step 1205. At Step 1210, the student's browser issues a DNS lookup for location of the content delivery system (CDS) web server. After the student's browser issues a DNS lookup for location of content delivery system web server, at Step 1215, the DNS returns an IP address for the CDS web server to the student's browser.

After the DNS returns an IP address for the CDS web server to the student's browser, at Step 1220, the student's browser issues an HTTP request to the CDS web server for the requested curriculum page. After the student's browser issues the HTTP request to the CDS web server for the requested curriculum page, at Step 1225, the CDS web server issues a request to the content service to the get the XML data for the page. After the CDS web server issues a request to the content service to the get the XML data for the page, at Step 1230, the content service communicates with the delivery database to retrieve the XML data.

After the content service communicates with the delivery database to retrieve the XML data, at Step 1235, the delivery database returns the requested data. After the delivery database returns the requested data, the process proceeds to Step 1240. At Step 1240, if all the data for the page is not obtained, the process proceeds to Step 1230. If, at Step 1240, all the data for the page is obtained, the process proceeds to Step 1245. At Step 1245, the content service returns the XML data for the page as requested. After the content service returns the XML data for the page as requested, at Step 1250, the CDS web server process the XML data and produces an HTML page, which is returned to the student's browser. The process proceeds to Step 1255. If, at Step 1255, the page has embedded resources, HTTP requests are made for each embedded resource. After the HTTP requests are made for each embedded resource, the process proceeds to Step 1260. If, at Step 1255, the page does not have embedded resources, the process proceeds to Step 1260. At Step 1260, the dynamically generated curriculum process 1200 is complete.

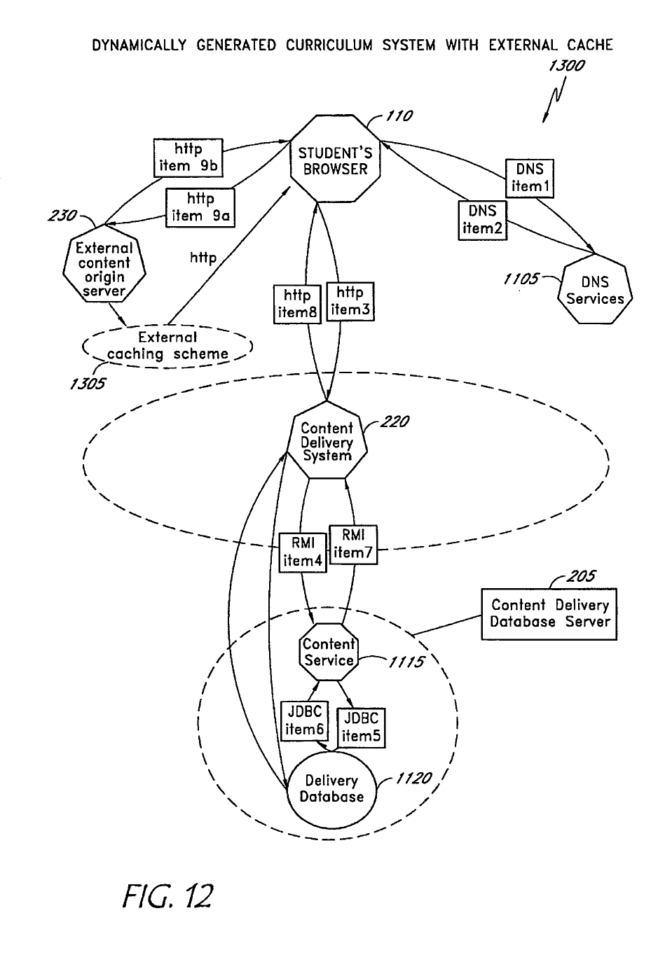

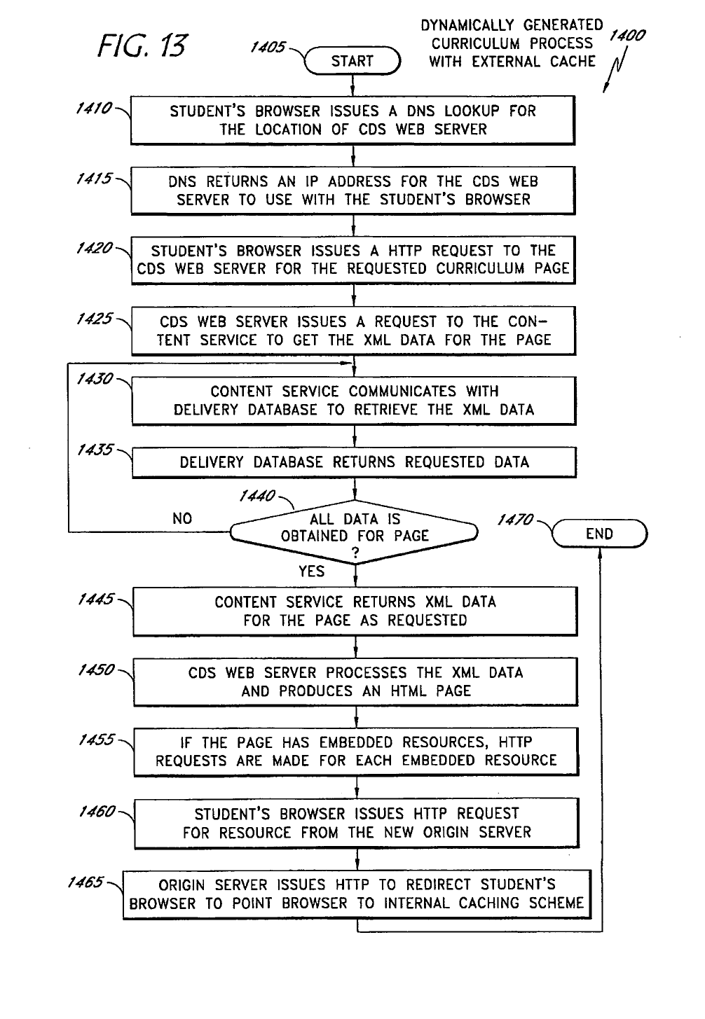

FIG. 12 is a block diagram showing one embodiment of a dynamically generated curriculum system with external cache 1300. As shown in the embodiment of FIG. 12, the dynamically generated curriculum system with external cache 1300 includes the student's browser 110, the DNS services 1105, the content delivery system 220, the content delivery database server 205, the content service 1115, the delivery database 1120, the external content origin server 230, and an external caching scheme 1305. In one embodiment, the student's browser 110 and the DNS services 1105 communicate by transmitting DNS items.

In this embodiment, the student's browser 110 and the content delivery system 220 communicate via HTTP. The content delivery system 220 and the content service 1115 communicate by Remote Method Invocation (RMI). The content delivery system 220 also communicates with the delivery database 1120. The content service 1115 and the delivery database 1120 are capable of communicating via JDBC. The content delivery database server 205 communicates with the content service 1115 and the delivery database 1120. The student's browser 110 and the external content origin server 230 communicate via HTTP. The external content origin server 230 transmits commands to the external caching scheme 1305, and the external caching scheme 1305 transmits, via HTTP, data to the student's browser 110. In one embodiment, the delivery database 1120 is a database such as those commercially available from Oracle, or the like.

FIG. 13 illustrates one embodiment of a process 1400 for dynamically generating a curriculum with external cache. This embodiment of the dynamically generated curriculum process with external cache 1400 starts at Step 1405. At Step 1410, the student's browser issues a DNS lookup for the location of the content delivery system (CDS) web server. After the student's browser issues a DNS lookup for location of the content delivery system web server, at Step 1415, the DNS returns an IP address for the CDS web server to use with the student's browser.

After the DNS returns an IP address for the CDS web server to use with the student's browser, at Step 1420, the student's browser issues an HTTP request to the CDS web server for the requested curriculum page. After the student's browser issues an HTTP request to the CDS web server for the requested curriculum page, at Step 1425, the CDS web server issues a request to the content service to the get the XML data for the page. After the CDS web server issues a request to the content service to the get the XML data for the page, at Step 1430, the content service communicates with the delivery database to retrieve the XML data. After the content service communicates with the delivery database to retrieve the XML data, at Step 1435, the delivery database returns the requested data.

After the delivery database returns the requested data, the process proceeds to Step 1440. At Step 1440, if all the data for the page is not obtained, the process proceeds to Step 1430. If, at Step 1440, all the data for the page is obtained, the process proceeds to Step 1445. At Step 1445, the content service returns the XML data for the page as requested. After the content service returns the XML data for the page as requested, at Step 1450, the CDS web server processes the XML data and produces an HTML page, which is returned to the student's browser. The process proceeds to Step 1455. If, at Step 1455, the page has embedded resources, HTTP requests are made for each embedded resource.

In one embodiment, the URL of the embedded resources are modified based on the location of the external caching origin server. After the HTTP requests are made for each embedded resource, the process proceeds to Step 1460. If, at Step 1455, the page does not have embedded resources, the process proceeds to Step 1460. At Step 1460, the student's browser issues an HTTP request for the resource from the new origin server determined and coded into the URL in Step 1450. After the student's browser issues the HTTP request for the resource from the new origin server, at Step 1465, the origin server issues an HTTP request to redirect the student's browser to point the browser to its internal caching scheme. After the origin server issues the HTTP request to redirect to the student's browser to point the browser to its internal caching scheme, the process proceeds to Step 1470. At Step 1470, the dynamically generated curriculum process with external cache 1400 is complete.

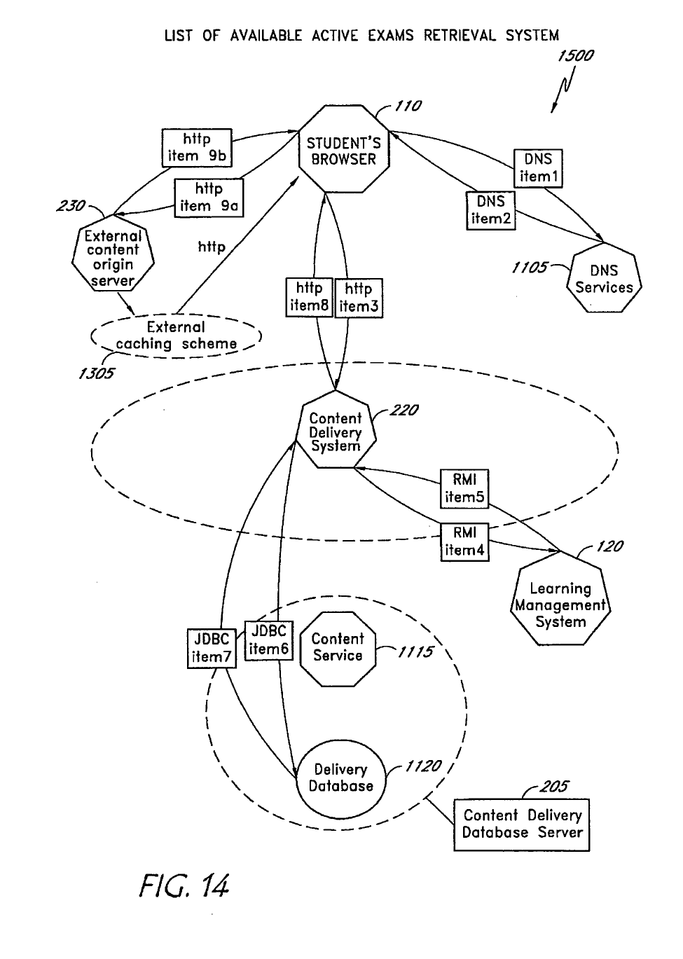

FIG. 14 illustrates a block diagram of a list of available active exams retrieval system 1500, according to aspects of an embodiment of the invention. As shown in the embodiment of FIG. 14, the list of available active exams retrieval system 1500 includes the student's browser 110, the DNS services 1105, the content delivery system 220, the learning management system 120, the content service 1115, the delivery database 1120, the content delivery database server 205, the external content origin server 230, and the external caching scheme 1305. In this embodiment, the student's browser 110 and the DNS services 1105 communicate by transmitting DNS items. The student's browser 110 and the content delivery system 220 communicate via HTTP. The content delivery system 220 and the content service 1115 communicate by Remote Method Invocation (RMI). The content delivery system 220 and the delivery database 1120 communicate via JDBC. The content service 1115 and the delivery database 1120 communicate using JDBC.

The content delivery database server 205 is capable of communicating with the content service 1115 and the delivery database 1120. The learning management system 120 and the content delivery system 220 can communicate using RMI. The student's browser 110 and the external content origin server 230 communicate via HTTP. The external content origin server 230 is capable of transmitting commands to the external caching scheme 1305, and the external caching scheme 1305 transmits, via HTTP, data to the student's browser 110. In one embodiment of the invention, the delivery database 1120 is a database such as those commercially available from Oracle, or the like.

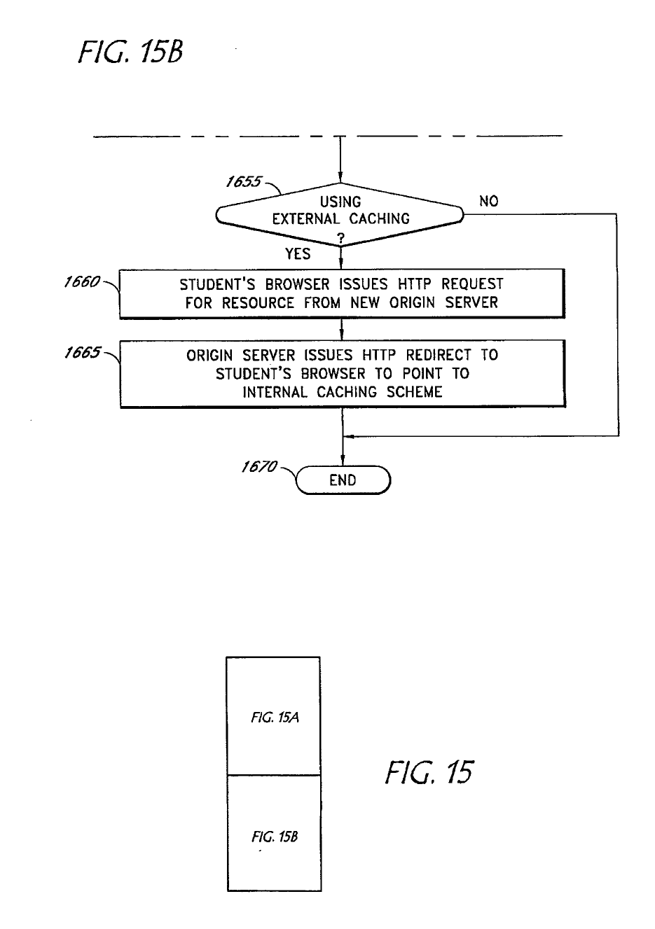

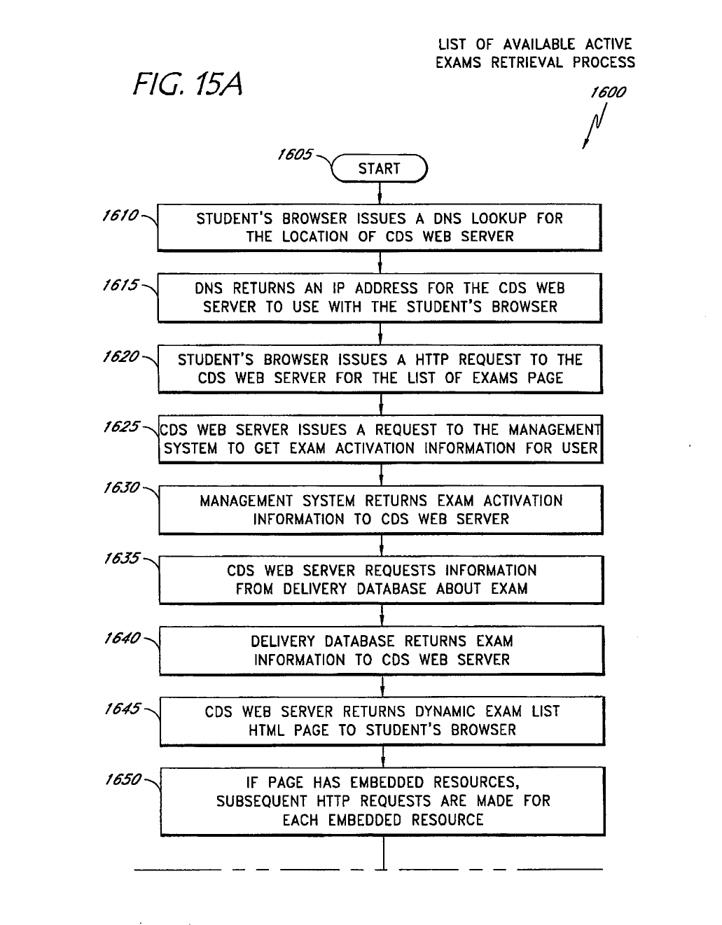

FIG. 15 illustrates a process flow diagram of a list of available active exams retrieval process 1600, according to aspects of an embodiment of the present invention. The list of available active exams retrieval process 1600 starts at Step 1605. At Step 1610, the student's browser issues a DNS lookup for the location of the content delivery system (CDS) web server. After the student's browser issues a DNS lookup for the location of the content delivery services web server, at Step 1615, the DNS returns an IP address for the CDS web server to use with the student's browser.

After the DNS returns an IP address for the CDS web server to use with the student's browser, at Step 1620, the student's browser issues an HTTP request to the CDS web server for the list of exams page. After the student's browser issues the HTTP request to the CDS web server for the list of exams page, at Step 1625, the CDS web server issues a request to the management system to get the exam activation information for the particular user. After the CDS web server issues a request to the management system to get the exam activation information for the particular user, at Step 1630, the management system returns the exam activation information to the CDS web server. After the management system returns the exam activation information to the CDS web server, at Step 1635, the CDS web server requests information from the delivery database about the exam. After the CDS web server requests information from the delivery database about the exam, at Step 1640, the delivery database returns the exam information to the CDS web server.

If external caching is used, the URL of the embedded resources may be customized based on the location of the external caching origin server. After the delivery database returns the exam information to the CDS web server, at Step 1645, the CDS web server returns the dynamic exam list HTML page to the student's browser. After the CDS web server returns the dynamic exam list HTML page to the student's browser, the process proceeds to Step 1650. At Step 1650, if the page has embedded resources, HTTP requests are made for each embedded resource, and the process proceeds to Step 1655. If, at Step 1650, the page has no embedded resources, the process proceeds to Step 1655.

At Step 1655, if external caching is not used, the process proceeds to Step 1670. If, at Step 1655, external caching is used, the process proceeds to Step 1660. At Step 1660, the student's browser issues an HTTP request for the resource from the new origin server determined and coded into the URL in Step 1640. After the student's browser issues the HTTP request for the resource from the new origin server, at Step 1665, the origin server issues an HTTP redirect to the student's browser to point the browser to its internal caching scheme. After the origin server issues the HTTP redirect to the student's browser to point the browser to its internal caching scheme, the process proceeds to Step 1670. At Step 1670, the list of available active exams retrieval process 1600 is complete.

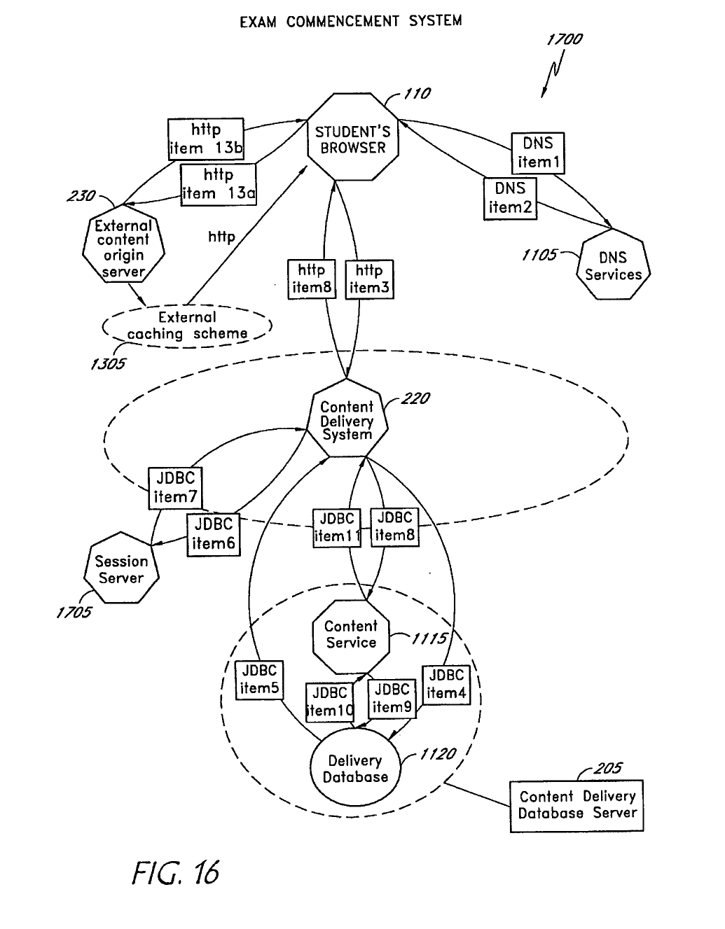

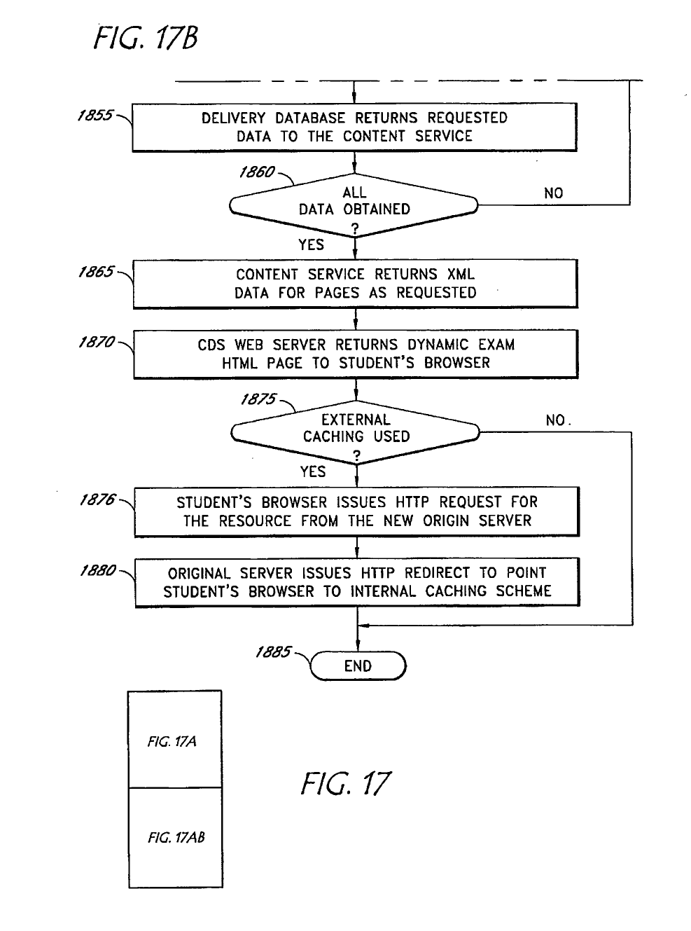

FIG. 16 illustrates a block diagram of an exam commencement system 1700, according to aspects of an embodiment of the invention. As shown in the embodiment of FIG. 16, the exam commencement system 1700 includes the student's browser 110, the DNS services 1105, the content delivery system 220, the content service 1115, the delivery database 1120, the content delivery database server 205, the external content origin server 230, the external caching scheme 1305, and a session server 1705. In one embodiment of the invention, the student's browser 110 and the DNS services 1105 communicate by transmitting DNS items. The student's browser 110 and the content delivery system 220 communicate via HTTP. The content delivery system 220 and the content service 1115 communicate by JDBC.

In one embodiment, the content delivery system 220 and the delivery database 1120 communicate using JDBC. The content service 1115 and the delivery database 1120 communicate using JDBC. The content delivery database server 205 communicates with the content service 1115 and the delivery database 1120. The session server 1705 and the content delivery system 220 communicate by JDBC. The student's browser 110 and the external content origin server 230 communicate via HTTP. The external content origin server 230 transmits commands to the external caching scheme 1305, and the external caching scheme 1305 transmits, via HTTP, to the student's browser 110. In one embodiment, the delivery database 1120 is a database such as those commercially available from Oracle, or the like.

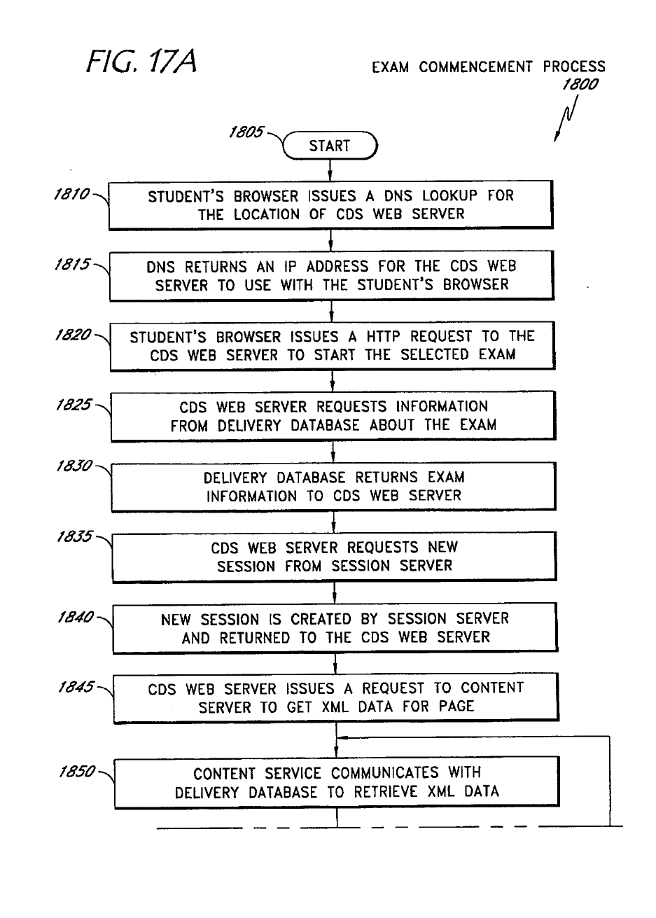

FIG. 17 illustrates a process flow diagram of an exam commencement process 1800, according to aspects of an embodiment of the invention. This embodiment of the exam commencement process 1800 starts at Step 1805. At Step 1810, the student's browser issues a DNS lookup for the location of the content delivery system (CDS) web server. After the student's browser issues a DNS lookup for location of the content delivery system web server, at Step 1815, the DNS returns an IP address for the CDS web server to use with the student's browser. After the DNS returns an IP address for the CDS web server to use with the student's browser, at Step 1820, the student's browser issues an HTTP request to the CDS web server to start the selected exam. After the student's browser issues the HTTP request to the CDS web server to start the selected exam, at Step 1825, the CDS web server requests information from the delivery database about the exam.

After the CDS web server requests information from the delivery database about the exam, at Step 1830, the delivery database returns the exam information to the CDS web server. After the delivery database returns the exam information to the CDS web server, at Step 1835, the CDS web server requests a new session from the session server. After the CDS web server requests a new session from the session server, at Step 1840, a new session is created by the session server and returned to the CDS web server. After the new session is created by the session server and returned to the CDS web server, at Step 1845, the CDS web server issues a request to the content server to get the XML data for the page. After the CDS web server issues a request to the content server to get the XML data for the page, at Step 1850, the content service communicates with the delivery database to retrieve the XML data.

After the content service communicates with the delivery database to retrieve the XML data, at Step 1855, the delivery database returns the requested data to the content service, and the process proceeds to Step 1860. At Step 1860, if all the data is not obtained, the process proceeds to Step 1850. If, at Step 1860, all the data is obtained, the process proceeds to Step 1865. At Step 1865, the content service returns the XML data for the pages as requested. After the content service returns the XML data for the pages as requested, at Step 1870, the CDS web server returns the dynamic exam HTML page to the student's browser. If, at Step 1870, the page has embedded resources, subsequent HTTP requests are made for each embedded resource. The process proceeds to Step 1875.

If, at Step 1875, external caching is used, the URL of the embedded resources based on the location of the external caching origin server, and the process proceeds to 1876. If, at Step 1875, external caching is not used, the process proceeds to Step 1885. At Step 1876, the student's browser issues an HTTP request for the resource from the new origin server determined and coded into the URL in Step 1840. After, the student's browser issues the HTTP request for the resource from the new origin server, at Step 1880, the origin server issues an HTTP redirect to the student's browser to point the browser to the internal caching scheme. After the origin server issues the HTTP redirect to the student's browser to point the browser to the internal caching scheme, the process proceeds to Step 1885. At Step 1885, the exam commencement process 1800 is complete.

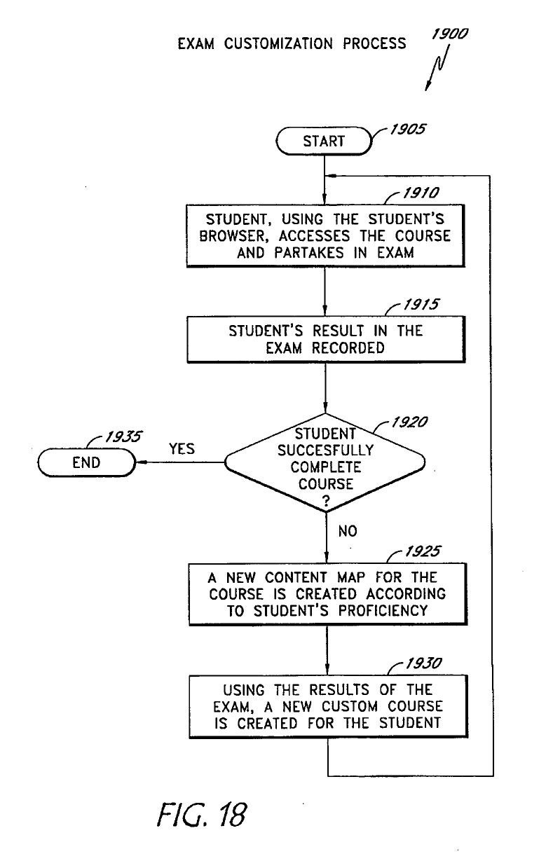

FIG. 18 illustrates a process flow diagram of an exam customization process 1900, according to aspects of an embodiment of the invention. This embodiment of the exam customization process 1900 starts at Step 1905. At Step 1910, the student, using the student's browser, accesses the course. After completing the course, the student partakes in an exam. After the student partakes in the exam, at Step 1915, the student's results in the exam are recorded. After the student's results in the exam are recorded, the process proceeds to Step 1920. At Step 1920, if the student has successfully completed the course, the process proceeds to Step 1935. If, at Step 1920, the student has not successfully completed the course, the process proceeds to Step 1925.

At Step 1925, a new target indicators content map for the course is created according to the student's proficiency in the exam at Step 1910. After the new target indicators content map for the course is created, at Step 1930, using the results of the exam at Step 1910 and the new target indicators content map created in Step 1925, a new custom course is created for the particular student. After the new custom course is created for the particular student, the process proceeds to Step 1910. At Step 1935, the exam customization process 1900 is complete.

In one embodiment, the system dynamically creates a course before presenting the course to the student. Therefore, in the same manner, the system is able to create supplementary courses based upon the student's proficiency in the course exam. In this way, the courses presented to a student may be personalized for that student and to that student's learning progress.

As an example, the course content may be presented to a student through an HTML page containing one or more content items. Using the relationship of assessment items to content items and pages, a course can be created to address the student's proficiency in the course exam. The system creates a map of target indicators, content items, and pages specific for the particular student based on the student's failed assessment items. The system is capable of storing the map in the student's profile. Thus, using the profile, the system provides each student with a course based on the course content not mastered by the student.

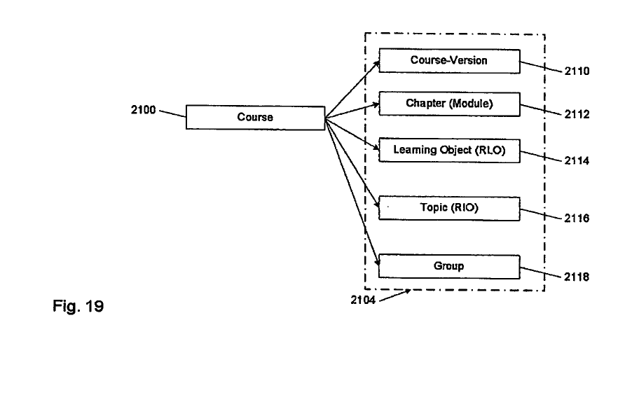

FIG. 19 is a block diagram illustrating relationships between a course 2100 and content items in other courses. Other content items 2110, 2112, 2114, 2116, and 2118 may be authored and maintained as part of a second course 2104. For example, in one embodiment, the course 2100 may be an 8th grade math curriculum. However, learning objectives of the course may include prerequisite content that is part of the 7th grade curriculum. The linkage between the 8th grade and 7th grade objects is a product of the leaning objectives, e.g., a taxonomy of what learning objects should be provided to the learner, regardless of any boundaries that result from creation of courses 2100 and 2104.

In one embodiment, the course 2100 may link to content items in another course at different levels of detail, e.g., not merely between courses, but between courses and course-version pairs, learning modules, learning objects, topics, or groups.

In one embodiment, the authoring system 115 is configured to allow linking to content in other courses. This allows the creation of cross-course data links in addition to allowing definition of new content from the intra-course links as described above. The data links to other courses may be stored in any form such as would be apparent to one of skill in the art, including a pointer, a file or reference to a URL. In one embodiment, the authoring system 115 allows an author to link to previously defined content items. In addition, the authoring system 115 may also allow the author to link to content that has not yet been defined so as to allow the author to define the linked content items in any order. In one embodiment, the author may reference the not-yet-defined content item by providing identifying information, e.g., a title, of the not-yet-defined content item. In other embodiments, the author may link to the not-yet-defined content item using any linking or referencing technique such as would be apparent to one of skill in the art.

In one embodiment, the delivery engine 105 may include a content importer that is configured to initially process learning content as it is loaded from storage or outside sources. In one embodiment the storage is the database server 205 (FIG. 2). The content importer may be configured to recognize cross-course links based on the referenced URL. When such a link is encountered, the content importer may “walk up” the course tree to build a parent-child hierarchy of the linked content. If the link is invalid, the content importer may indicate an error to the author, or user by displaying an error message or terminating the import session. However, in one embodiment the error is ignored, and the invalid link remains within the course allowing the corresponding content to be defined after the linking content has been defined.

When the link is determined to be valid, the content of the cross-course link is imported into the current course. In one embodiment, the cross-course linked content is not imported until the link is accessed by the learner. The content delivery engine 105 (FIG. 2) may render the contents of the cross-course links in particular themes or styles as configured for the source or linking course 1200.

In some embodiments, cross-course links may define circular links between one or more courses. In one embodiment, the cross-course links are re-imported when encountered to complete the circular links. For example, if Course A references Course B, which references Course A, importing Course A and then importing course B establishes the link from Course B to Course A. Re-importing Course A a second time will establish and complete the circular link from Course A to Course B.

In one embodiment, when a learner encounters cross-course links, a new window is opened to show the linked course. In one embodiment, the new window removes links to the previous (linking) content, for example, to minimize possible angst by a learner who follows a cross-course link to a prerequisite or lower level course. In one embodiment, the new window for the cross-course link may provide a link back to the window containing the original, linking, content.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being redefined herein to be restricted to including any specific characteristics of the features or aspects of the invention with which that terminology is associated. The scope of the invention should therefore be construed in accordance with the appended claims and any equivalents thereof.

We claim:

1. An online teaching system, comprising:
a first online course, wherein said course comprises first data objects comprising first course material to be taught to a first student; and
a second online course, wherein said course comprises second data objects comprising second course material to be taught to a second student, and wherein said second online course further comprises a data link to one or more of said first data objects.

2. The online teaching system of claim 1, wherein said online teaching system is an Internet based online teaching system.

3. The online teaching system of claim 1, wherein said first data objects are Extensible Markup Language (XML) data objects.

4. The online teaching system of claim 1, wherein said second data objects are Extensible Markup Language (XML) data objects.

5. The online teaching system of claim 1, wherein said data link comprises a data pointer.

6. The online teaching system of claim 1, wherein said data link comprises a Uniform Resource Locator (URL)

7. The online teaching system of claim 1, wherein said online teaching system dynamically renders said first course material to said first student.

8. The online teaching system of claim 1, wherein said online teaching system dynamically renders said second course material to said second student.

9. The online teaching system of claim 1, wherein said first and second data objects comprise data links to electronic photographs, text, videos or graphical images.

10. The online teaching system of claim 1, wherein said first and second data objects comprise electronic photographs, text, videos or graphical images.

11. A method of presenting course material to a student, comprising:
providing a first teaching course to a first student, wherein said first teaching course comprises first data objects comprising course material; and
providing a second teaching course to a second student, wherein said second teaching course comprises second data objects comprising course material, and wherein said second teaching course further comprises a data link to said first data objects.

12. The method of claim 11, wherein said providing a first teaching course comprises dynamically rendering course material to a browser on said first student's computer.

13. The method of claim 11, wherein said providing a second teaching course comprises dynamically rendering course material to a browser on said second student's computer.

14. The method of claim 11, wherein said first data objects and said second data objects comprise data links to electronic photographs, videos, text or graphical images.

15. The method of claim 11, wherein said first data objects and said second data objects comprise electronic photographs, videos, text or graphical images.

16. The method of claim 11, wherein said first data objects comprise Extensible Markup Language (XML) data objects.

17. The method of claim 11, wherein said second data objects comprise Extensible Markup Language (XML) data objects.

18. The method of claim 11, wherein said data link comprises a Uniform Resource Locator (URL).

19. An online teaching system configured to allow cross course linking between courses, comprising:
means for providing a first teaching course to a first student, wherein said first teaching course comprises first data objects comprising course material; and
means for providing a second teaching course to a second student, wherein said second teaching course comprises second data objects comprising course material, and wherein said second teaching course further comprises a data link to said first data objects.

20. The system of claim 19, wherein said means for providing a first teaching course comprises a dynamic delivery system configured to dynamically render said first teaching course to a browser on said first student's computer.

21. The system of claim 19, wherein said means for providing a second teaching course comprises a dynamic delivery system configured to dynamically render said second teaching course to a browser on said second student's computer.

22. The system of claim 19, wherein said data link comprises a Uniform Resource Locator (URL).
